(19) United States
(12) Patent Application Publication
(10) Pub. No.: US 2006/0009274 A1
(43) Pub. Date: Jan. 12, 2006

(54) Method of playing a game of roulette

(76) Inventor: Richard Finocchio, Everett, MA (US)

Correspondence Address: KENYON & KENYON, ONE BROADWAY, NEW YORK, NY, 10004, US

(21) Appl. No.: 10/887,997

(22) Filed: Jul. 8, 2004

(51) Int. Cl. A63F 13/00

(52) U.S. Cl. 463/17; 463/16

(57) ABSTRACT

A method for playing a game of chance and system for facilitating the play of the game are disclosed. The method of playing the game of chance may include placing bet using an entry form having markable areas associated with a table layout for a casino game. The method of playing the game may further include receiving a prize if the placed bet matches a winning number or an associated characteristic of the winning number, where the winning number may be generated from a set of numbers displayed in the table layout.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Roulette may be one of the oldest and most popular casino games in the world. In Roulette, a ball is spun around the rim of a wheel as a carousel turns in the other direction. When the ball slows it rolls down the sloping sides of the wheel's base and collides with the metal frame of the carousel, which is divided up into numbered slots. The ball eventually comes to rest in one of the slots and the number of that slot is deemed the winning number.

The Roulette wheel is associated with and may sit, for example, on a Roulette table that has a layout design with numbers drawn on it that correspond to those in the wheel. Bets placed on, or associated with, the winning number on the layout may be rewarded with a prize payout. There may be different odds payouts associated with different types of bet selections.

A Roulette wheel may feature, for example, a total of 37 or 38 slots, numbered 0 to 36 with an optional “00” slot. In particular, the 38-number Roulette wheel, sometimes referred to as an American Roulette wheel, may include both the “0” and “00”, whereas a 37-number casino Roulette wheel, sometimes referred to as a European Roulette wheel, may include the “0” but not the “00”.

The numbered slots of a Roulette wheel may be, for example red, black, or green. In a 38-number Roulette wheel, for example, the numbers 1 to 36 are arranged in a layout of alternating red and black colors, whereas the “0” and “00” are arranged in green.

A Roulette table may be divided, for example, in a layout of two sections—an inner section that has each individual instance of the numbers present on the Roulette wheel, and an outside section that has areas which correspond to a characteristic of each number, as opposed to the number itself. In this regard, the inner section of a Roulette table layout for a 38-number Roulette wheel, may include, for example, the numbers 1 through 36 arranged in three columns and twelve rows, plus a “0” and “00” arranged directly above the columns, and the outside section may include, for example, boxes arranged along the borders with numbers, text, and/or symbols.

Prior to a spin of the Roulette wheel, players may place bets on the Roulette table layout, using, for example, casino chips. Depending on where the chips are positioned, bets may be “inside” or “outside”. Inside bets are made on specific numbers or combinations of numbers within the number layout or along the border. Outside bets are made on a group of numbers, or some binding characteristic.

Inside bets may include, for example, a straight-up bet, a split bet, a street bet, a corner bet, a five-number bet, and a line bet. Outside bets may include, for example, a red/black bet, an odd/even bet, a low/high bet, a column bet, and a dozen bet. Each example bet type is further discussed below.

A straight-up bet is made on a single number (including 0 or 00) by placing one or more chips squarely in the center of a particular number on the table layout. If the Roulette ball lands on the particular number, the player of the straight bet wins. In this regard, the player may be paid, for example, 35 to 1 with respect to the wagered amount.

A split bet is made on any two adjoining numbers (including 0 or 00) by placing one or more chips on a line separating the two numbers. If the Roulette ball lands on either of the two numbers, the player of the split bet wins. In this instance, the player may be paid, for example, 17 to 1 with respect to the wagered amount.

A street bet is made on three numbers in a row by placing one or more chips on the outside line of a row. If the Roulette ball lands on any of the three numbers, the player of the street bet wins. In this regard, the player may be paid, for example, 11 to 1 with respect to the wagered amount.

A corner bet is made on four adjoining numbers that form a square by placing one or more chips where the four corners converge. If the Roulette ball lands on any of the four numbers, the player of the corner bet wins. In this instance, the player may be paid, for example, 8 to 1 with respect to the wagered amount. A corner bet may also be referred to as “square” or “quarter” bet.

A five-number bet is made on 0, 00, 1, 2, and 3 by placing one or more chips on the corner of the intersection of 0, 1, and the first row of numbers. If the Roulette ball lands on 0, 00, 1, 2, or 3, the player of the five-number bet wins. In this instance, the player may be paid, for example, 6 to 1 with respect to the wagered amount.

A line bet is made on two adjacent rows of numbers by placing one or more chips on one of the outside lines at the interaction of the two rows. If the Roulette ball lands on any of numbers of the two adjacent rows, the player of the line bet wins. In this regard, the player may be paid, for example, 5 to 1 with respect to the wagered amount.

A red/black bet is made on the color red or the color black by placing one or more chips in a box outside the table indicating the particular color, i.e. “Red” or “Black”. If the Roulette ball lands on the particular color, the player of the color bet wins. In this regard, the player may be paid, for example, 1 to 1 (“even money”) with respect to the wagered amount.

An odd/even bet is made on all odd numbers or all even numbers by placing one or more chips in a box outside the table indicating “Odd” or “Even”. If the Roulette ball lands on any of the odd numbers, the player of the odd bet wins, and if the Roulette ball lands on any of the even numbers, the player of the even bet wins. In either instance, the player may be paid, for example, 1 to 1 (even money) with respect to the wagered amount.

A low/high bet is made on a range of lower numbers (1-18) or a range of high numbers (19-31) in a box indicating the range, or alternatively, “High” or “Low”. If the Roulette ball lands on any of the lower range numbers, the player of the low bet wins, and if the Roulette ball lands on any of the high numbers, the player of the high bet wins. In either instance, the player may be paid, for example, 1 to 1 (even money) with respect to the wagered amount.

A column bet is made on 12 numbers contained in a first, second, or third column of the table layout. In this regard, the first column of numbers of a 38-numbered Roulette game may include, for example, the numbers 1, 4, 7, 10, 13, 16, 19, 22, 25, 28, 31, 34; the second column of numbers may include, for example, the numbers 2, 5, 8, 11, 14, 17, 20, 23, 26, 29, 32, 35, and the third column of numbers may include, for example, the numbers 3, 6, 9, 12, 15, 18, 21, 24, 27, 30, 33, 36.

The column bet may be made by placing one or more chips in a box outside the table and directly below a particular column. If the Roulette ball lands on any of the numbers of the particular column, the player of the column bet wins. In this instance, the player may be paid, for example, 2 to 1 with respect to the amount wagered.

A dozen bet is made on a first, second, or third dozen numbers. In this regard, the first dozen numbers may include, for example, the numbers 1 to 12; the second dozen numbers may include, for example, 13 to 24; and the third dozen numbers may include, for example, 25 to 36.

The dozen bet may be made by placing one or more chips in a box outside of the table indicating, for example, the range of numbers in a particular dozen. If the Roulette ball lands on any of the numbers of the particular dozen, then player of the dozen bet wins. In this instance, the player may be paid, for example, 2 to 1 with respect to the amount wagered.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example ticket, according to an example embodiment of the present invention.

FIG. 2 illustrates an example entry form, according to an example embodiment of the present invention.

FIG. 3 illustrates an alternative example entry form, according to an example embodiment of the present invention.

FIG. 4 illustrates an example procedure for playing a game of chance, according to an example embodiment of the present invention.

FIG. 5 illustrates an example procedure for facilitating the play of a game of chance, according to an example embodiment of the present invention.

FIG. 6 illustrates an example display screen, according to an example embodiment of the present invention.

FIG. 7 illustrates a second example display screen, according to an example embodiment of the present invention.

FIG. 8 illustrates a third example display screen, according to an example embodiment of the present invention.

FIG. 9 illustrates an example game chart, according to an example embodiment of the present invention.

FIG. 10A illustrates an example ticket log for use in facilitating the play of a game of chance, according to an example embodiment of the present invention.

FIG. 10B illustrates an example entry from the example ticket log of FIG. 10A, according to an example embodiment of the present invention.

FIG. 11 illustrates an example lottery system for use in facilitating the play of a game of chance, according to an example embodiment of the present invention.

### DETAILED DECRIPTION OF EXAMPLE EMBODIMENTS

Example embodiments according to the present invention may include simulated roulette games. These games may be included as part of a conventional off-line ticket based lottery, or as part of an on-line lottery similar to Keno or other video-based lottery games.

In an example embodiment of the present invention, a customer may purchase a ticket for a chance in a game of Roulette, either simulated or actual. The ticket may be purchased for any combination of bets that may be placed on a conventional Roulette table or a modified version of an actual Roulette table. In order to acquire a ticket, at least one bet must be placed. At some time after the purchase of a ticket a Roulette wheel spin or simulation thereof may occur to generate a winning number. A bet on the ticket may be selected by the customer or randomly generated, e.g., by the game system, when a ticket is purchased. Based upon a comparison of the winning number and a bet, a customer may determine if the ticket is a winning ticket.

For example, a ticket may include a corner bet on the numbers 28, 29, 31, and 32. At some time after the ticket is purchased, a winning number is generated from a particular Roulette spin or simulation thereof. If the winning number generated is 28, 29, 31, or 32, the ticket is a winning ticket.

A winning ticket may be redeemed for a prize. The amount of the prize may vary depending on the bet. In this regard, the payoff odds of the bet may be configurable. For example, a corner bet of a winning ticket may be paid at odds of 6-1, rather than 8-1. It will be appreciated that the bets represented on a ticket may be used to play any casino game, and therefore are not limited to Roulette. Thus, a ticket may provide chances in different casino games.

Example Ticket for Playing a Game of Chance

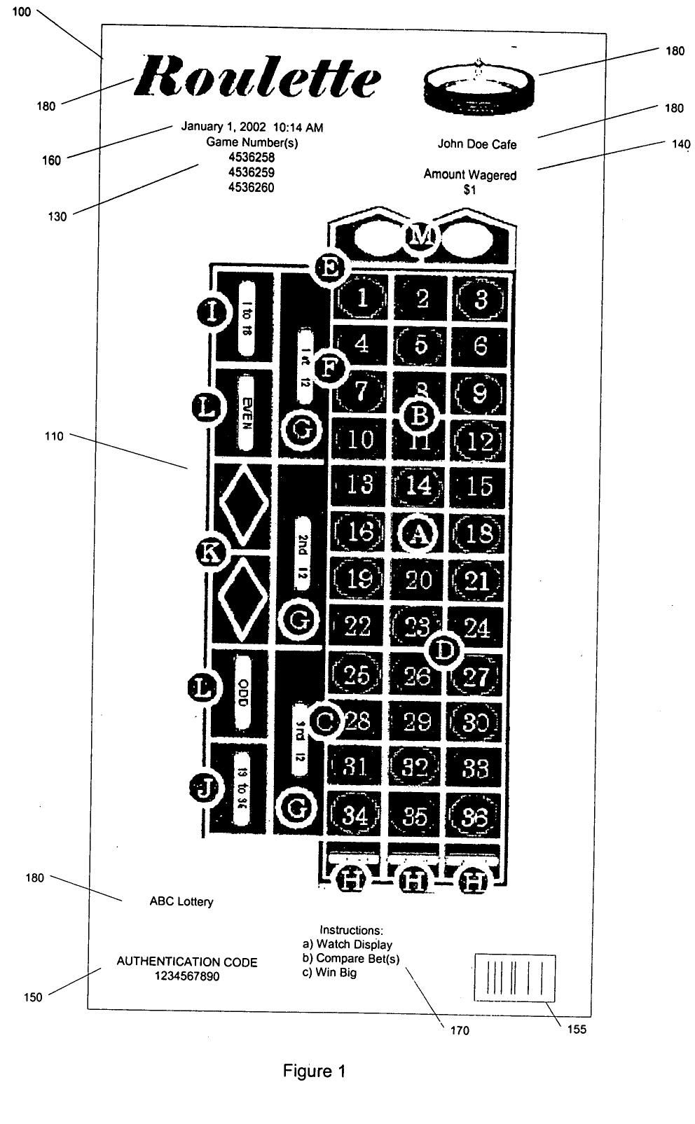

FIG. 1 illustrates an example ticket 100, according to an example embodiment of the present invention. The example ticket 100 may be received in a variety of ways, e.g., by requesting a ticket from a cashier or establishment operator or by purchasing a ticket from a vending machine that generates and/or disperses such tickets. The example ticket 100 may include a variety of information. For example, a ticket may include one or more bets, an authentication code, a time/date field, a drawing number field, game instructions, or an amount wagered field. It will be appreciated that a ticket may be received for a number of or several different games of chance. Additionally, multiple chances may be purchased in a single type of game.

The example ticket 100 may be for a casino-based game, such as Roulette or a simulation thereof. The example ticket 100 may be printed on a substrate, e.g., a printable substrate such as paper, card stock, plastic, or various laminates. Additionally, it will be appreciated that the example ticket 100 may be electronic or may be depicted on a display screen. Information may be displayed on both sides of the example ticket 100.

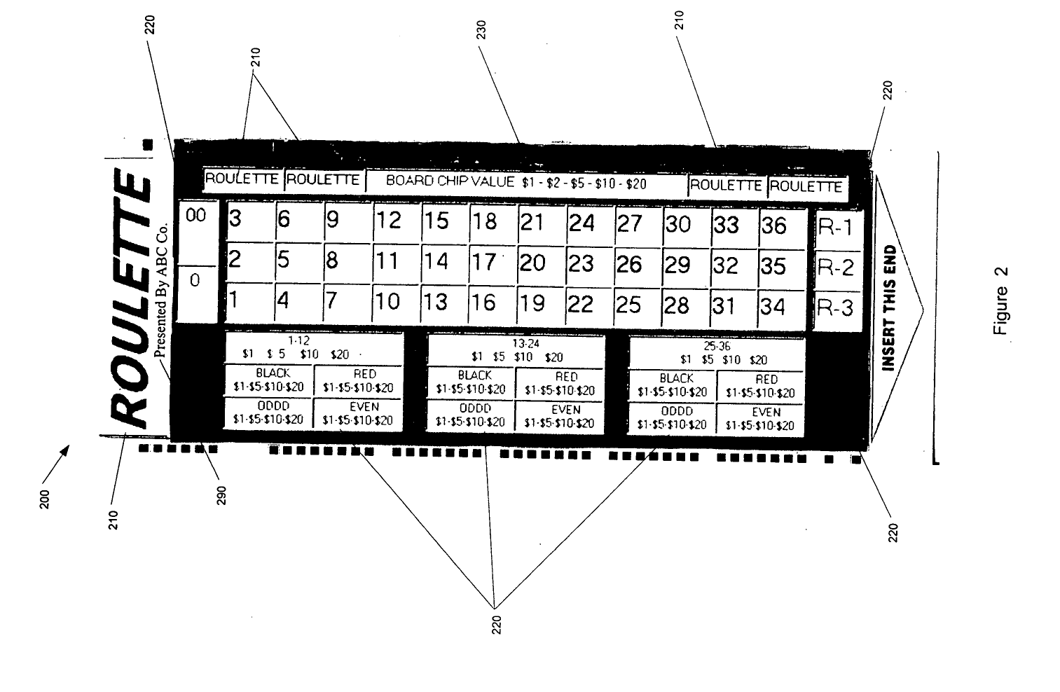

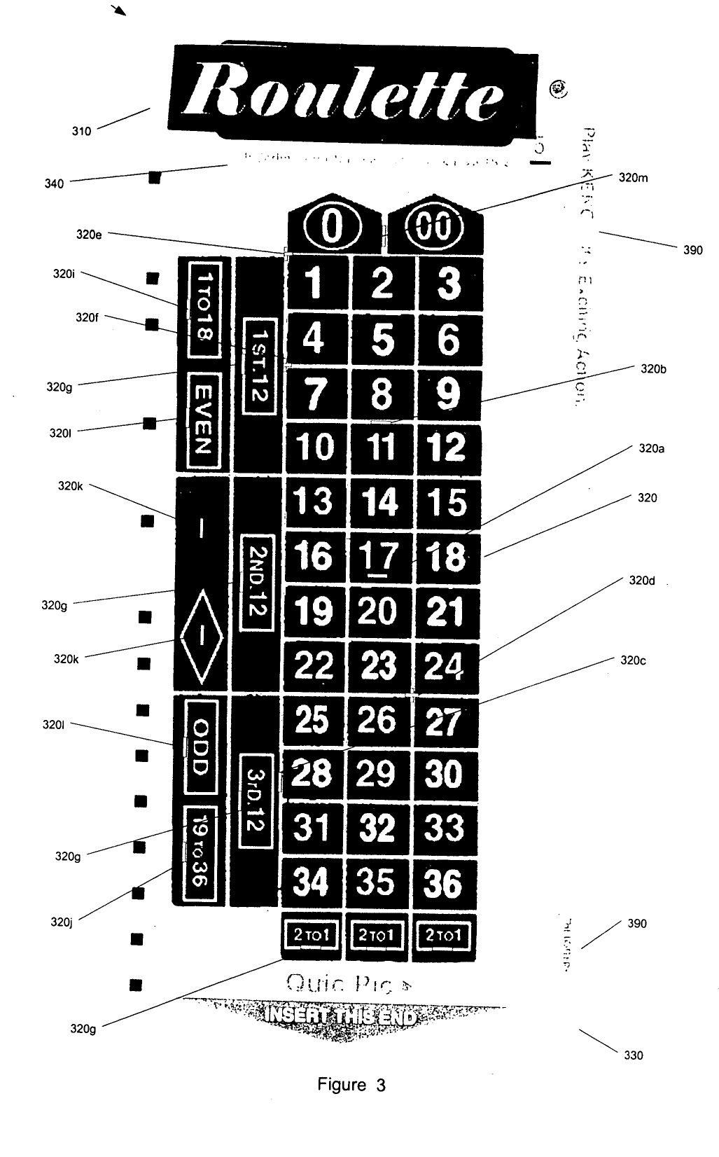

The example ticket 100 may include layout 110 with indications of one or more purchased bets A through M with regards to a game of Roulette. A player may place a bet, for example, by providing an indication on a bet slip (See FIGS. 2 and 3 discussed below). Alternatively, the player may place a bet via an interactive screen at a kiosk. The bet may include, for example, a straight-up bet, a split bet, a street bet, a corner bet, a five-number bet, a line bet, a an odd/even bet, a red/black bet, a column bet, a dozen bet, a low/high bet, or any combination thereof. For instance, depicted on example ticket 100 is a straight-up bet A placed on the number 17, a split bet B placed on the numbers 8 and 11, a street bet C placed on the numbers 28, 29, and 30, a corner bet D placed on the numbers 23, 24, 26, and 27, a five-number bet E placed on the numbers 0, 00, 1, 2, and 3, a line bet F placed on the numbers 4, 5, 6, 7, 8 and 9, a dozen bet G placed on numbers 1 to 12, 13 to 24, or 25 to 36, a column bet H on a particular column of numbers, a low bet 1 placed on the numbers 1 to 18, a high bet J placed on the numbers 19 to 36, a red/black bet K, an odd/even bet L, and a split bet M placed on the numbers 0 and 00. It will be appreciated that the type and/or amount of bets may vary according to the rules of the game.

The example ticket 100 may include a drawing identifier field 130. It will be appreciated that each Roulette spin may constitute a separate play of the game. The drawing identifier field 130 may represent the game number or the time of the drawing. The drawing identifier field 130 may also indicate the game or games that the ticket has been purchased for. For example, the game identifier field 130 may indicate that a ticket is for the next game available. However, it will be appreciated that the customer may select the game or games to be played and that the customer may reuse the same ticket for more than one game.

The example ticket 100 may include an amount wagered field 140, indicating the amount wagered on each bet in a game (e.g., “the chip value”). For example, FIG. 1 indicates that $1 is wagered on each bet A through K for a total wagered amount of $15. In will be appreciated that the amount wagered field 140 may alternatively indicate the total purchase price of the ticket.

The example ticket 100 may also include an authentication code 150, to uniquely identify the ticket. More digits may be provided for greater security. The authentication code 150 may include information required to authenticate the ticket when the ticket is redeemed. A machine-readable version of the authentication code 155 may also be provided on the example ticket 100. The machine-readable version of the authentication code 155 may be a bar code, e.g., a stacked linear bar code or two-dimensional bar code. A standard 2 of 5 or other conventional bar code may be employed. It will be appreciated that other forms of machine-readable information may be included on the ticket, in place of the bar codes, e.g., magnetic strips or smart card capability. It will also be appreciated that the machine-readable code 155 may also include other information, e.g., a checking code that may provide sufficient information to identify whether the ticket is a valid ticket without providing sufficient information to authenticate the ticket. Such a checking code may be used at a checking station so that customers may test whether they have valid tickets.

The example ticket 100 may include a time/date field 160, to indicate when the ticket was purchased or when the drawing for a particular play of the game is to occur.

The example ticket 100 may also include information not directly involved in the play of the game. For example, the example ticket 100 may include instructions 170 for playing the game or for the use and/or redemption of the ticket. Additionally, the instructions 170 may include a chart indicating the prize received depending on the type of bet.

It will be appreciated that other information 180 may be included in the example ticket, e.g., the identity of the agent selling the ticket, an identification number for the point of sale terminal that the ticket was sold from, additional advertising information, coupons, etc.

Rules of the game and/or legal disclaimers may be printed on the ticket, e.g., on the reverse side. Additional security and authentication information may also be added, e.g., multiple layer, special marks, etc.

Example Entry Form

FIG. 2 illustrates an example entry form 200 for facilitating the playing of a game of chance, according to an example embodiment of the present invention. The example entry form 200 may be used to acquire a ticket for the play of a game of chance. The example entry form 200 may be offered, for example, at establishments offering a game of chance and distributed to customers who wish to play. The example entry form 200 may be for a casino game, such as Roulette. The example entry form 200 may be located on a substrate, e.g., a printable substrate such as paper, card stock, plastic, or various laminates. Additionally, it will be appreciated that example entry form 200 may be electronic or depicted on a display. A customer may use an example entry form 200 to acquire a ticket. A customer may make indications on the form to indicate the customer's preferences, e.g., the selected bet, amount wagered, etc. Information may be found on both sides of the example entry form 200. The example entry form 200 and indications marked on the form may be machine readable such that a machine may generate a ticket using the example entry form 200.

The example entry form 200 may include a game type indication 210 to indicate the type of game for which the entry form 200 may be used to play. For example, in FIG. 2, the example entry form 200 indicates that the example entry form 200 may be used to play a Roulette game. In this regard, the example entry form 200 may include further indications representing various aspects of the game, including, for example, indications to represent a particular casino table layout, such as a Roulette table layout. It will be appreciated that the example entry form 200 may be configured in a variety of ways so that the example entry form 200 may be used for other games as well, including, for example, a game of craps or a conventional Keno-type game.

The example entry form 200 may include areas 220 to indicate a customer preference with respect to a bet type. In this regard, the customer may place an indication mark using, for example, a marking pencil or pen. The indication mark may be made, for example, by underlining, circling, marking an “X”, placing a dot and/or highlighting, etc.

The example entry form 200 may include a bet amount field 230 to indicate the amount of money that the customer would like to wager on a chance in a play of the game. For example, in FIG. 2 a player may wager $1, $2, $5, $10, or $20. It will be appreciated that the amounts listed in the bet amount field may vary.

The example entry form 200 may include a quantity of games field to select the number of games that the customer would like to play.

The example entry form 200 may also include information not directly involved in the play of a game. Located on the example entry form 200 may be instructions for playing the game or for the use of the example entry form 200. Additionally, the instructions may include a chart indicating the prize received depending on placed bet and the Roulette ball landing on particular number, color, etc.

It will be appreciated that other information 290 may be included in the example entry form 200, e.g., the identity of the agent providing the entry form, an identification number for the point of sale terminal that the entry form was received from, additional advertising information, coupons, etc. Rules of the game and/or legal disclaimers may be printed on the entry, e.g., on the reverse side. Additional security and authentication information may also be added, e.g., multiple layers, special marks, etc.

It will also be appreciated that the example entry form 200 may be combined with the example ticket 100. For example, the example entry form 200 may be provided on one side and the example ticket 100 may be produced on the back.

Alternative Example Entry Form

FIG. 3 illustrates an alternative example entry form 300 for facilitating the playing of a game of chance, according to an example embodiment of the present invention. The example entry form 300 may be used to acquire a ticket for the play of a game of chance. The example entry form 300 may be offered, for example, at establishments offering a game of chance and distributed to customers who wish to play. The example entry form 300 may be for a casino game, such as Roulette. The example entry form 300 may be located on a substrate, e.g., a printable substrate such as paper, card stock, plastic, or various laminates. Additionally, it will be appreciated that example entry form 300 may be electronic or depicted on a display. A customer may use an example entry form 300 to acquire a ticket. A customer may make indications on the form to indicate the customer's preferences. Information may be found on both sides of the example entry form 300. The example entry form 300 and indications marked on the form may be machine readable such that a machine may generate a ticket using the example entry form 300.

The example entry form 300 may include a game type indication 310 to indicate the type of game for which the entry form 300 may be used to play. For example, in FIG. 3, the example entry form 300 indicates that the example entry form 300 may be used to play a Roulette game. In this regard, the example entry form 300 may include further indications representing various aspects of the game, including, for example, indications to represent a particular casino table layout, such as the Roulette table layout. It will be appreciated that the example entry form 300 may be configured in a variety of ways so that the example entry form 300 may be used for other games as well, including, for example, a game of craps.

The example entry form 300 may include an area 320 to indicate a customer preference with respect to a bet type. In particular, the entry form 300 may include, for example, an area 320a to place a straight-up bet, an area 320b to place a split bet, an area 320c to place a street bet, an area 320d to place a corner bet, an area 320e to place a five-number bet, an area 320f to place a line bet, an area 320g to place a dozen bet, an area 320h to place a column bet, an area 320i to place a low numbers bet, an area 320j to place a high numbers bet, an area 320k to place a red/black bet, an area 3201 to place an odd/even bet, an area 320m to place a combined 0 and 00 bet. In this regard, the customer may place an indication mark using, for example, a marking pencil or pen. The indication mark may be made, for example, by underlining, circling, marking an “X”, and/or highlighting, etc.

The example entry form 300 may include a quick pic field 330 to indicate the desire by the customer that the bet(s) be automatically generated by the system rather than selected by the customer.

The example entry form 300 may include a quantity of games field to select the number of games that the customer would like to play.

The example entry form 300 may also include information not directly involved in the play of a game. Located on the example entry form 300 may be instructions 340 for playing the game or for the use of the example entry form 300. Additionally, the instructions may include a chart indicating the prize received depending on placed bet and the Roulette ball landing on particular number, color, etc.

It will be appreciated that other information 390 may be included in the example entry form 300, e.g., the identity of the agent providing the entry form, an identification number for the point of sale terminal that the entry form was received from, additional advertising information, coupons, etc. Rules of the game and/or legal disclaimers may be printed on the entry, e.g., on the reverse side. Additional security and authentication information may also be added, e.g., multiple layers, special marks, etc.

It will also be appreciated that the example entry form 300 may be combined with the example ticket 100. For example, the example entry form 300 may be provided on one side and the example ticket 100 may be produced on the back.

Example Procedure for Playing a Game of Chance

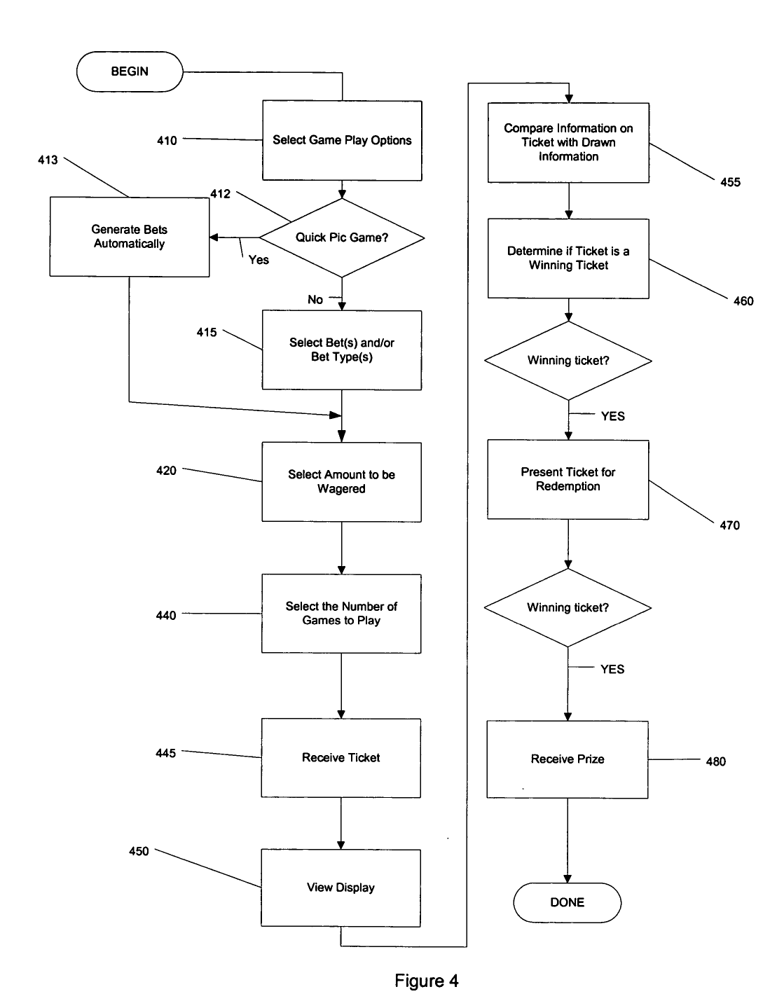

FIG. 4 illustrates an example procedure for playing a game of chance, according to an example embodiment of the present invention. In 410, a customer selects a game play option by marking an entry form, entering information on a machine or computer, or telling a clerk who may enter information for a customer. Game play options may include a game based upon a casino game, such as Roulette or a modified version of Roulette. It will be appreciated that other games may also be included in the game play options. For the rest of the procedure it will be assumed that a customer has selected to play a Roulette game. If a customer selects to play a quick pic game, the example procedure continues in 413 for system-generated bets, otherwise the procedure for playing the game continues in 415.

In 415, the customer may indicate his desired bet(s) and/or bet type(s). For example, a customer may indicate a straight-up bet to be placed on the number 17, a split bet on the numbers 8 and 11, and a corner bet on the numbers 23, 24, 26, and 27. It will be appreciated that the type and number of bets may vary depending on, inter alia, the rules of the game.

In 420, a customer may select the amount to be wagered. For example, the customer may select the dollar amount that is to be wagered for each bet in a game. A bet represents a single chance to win. For example, if a customer selects two bets, then for each game played the customer would have two separate chances at winning. In this regard, a customer may indicate a common dollar amount to be wagered for each bet, or alternatively, a different dollar amount may be wagered for each bet. Conversely, rather than indicating an amount for each bet, the customer may indicate the total amount to be wagered for a single game regardless of the number of bets placed. In this regard, the total amount to be wagered may be distributed equally among all placed bets.

In 440, a customer may select a quantity of games that the ticket can be played for. For example, if a customer wishes to play the same selected bet(s) for three games a customer may indicate so. A game may be each time information is drawn that allows a customer to determine whether a chance is a winning chance. A ticket may be a winning ticket if any of the bets on the ticket is a winning chance.

In 445, a customer receives a ticket. The ticket may contain indications of the information selected in 410 to 440. The ticket represents at least one chance in a game. The information selected in 410 to 440 may be processed into a ticket by an operator of a ticket device or the process may be automated. If the process is automated the information may be entered by the customer into a ticket machine that processes the information and generates a ticket.

In 450, a customer may view a display. The information on the display may include information regarding a winning number of a particular spin of a Roulette wheel or simulation thereof. For example, the winning number may be represented on a television (TV) or other monitor screen by a spinning wheel with a counter-spinning ball. At the drawing time, a winning number and/or category (e.g., red, black, odd, even, high, low, etc.) may be shown or highlighted. It will be appreciated that more than one approach may be employed to display or highlight the winning number and/or category. For example, each winning number and/or category may be shown one at a time, or a group of winning numbers/categories may be shown together with their corresponding game draw times.

In 455, a customer may compare the information on the ticket with information on the display. In particular, the customer may compare a drawn winning number to the bet(s) represented on the ticket.

In 460, a customer determines if a ticket is a winning ticket. If the winning number or characteristic of the winning number, such as its associated color or location within the table layout, correlates to a selection of the bet, the ticket is a winning ticket.

In 470, a customer presents a ticket for redemption. For example, the customer may present the ticket to the cashier or place it in a ticket validator. The gaming procedure may require tickets to be redeemed at the same establishment where they are sold, or may allow a ticket to be redeemed at a future time and at various locations. The ticket may be authenticated to determine whether the ticket is a valid winning ticket, e.g., if the ticket is a winning ticket and has not previously been redeemed. The authentication may be performed using an authentication code that uniquely identifies the ticket. Conventional schemes for authenticating ticket numbers may be employed, e.g., the authentication number may be used as part of a public key encryption system. The authentication may be performed by first ensuring that the ticket is a winning ticket.

In 480, if the ticket is a valid winning ticket, a customer may receive a prize for the winning ticket. The prize may be cash or anything of value, e.g., additional tickets. The prize may vary based on the number of matching symbols, the quantity of the spot number, the rules of the game, etc.

Example Procedure for Facilitating the Play of a Game of Chance

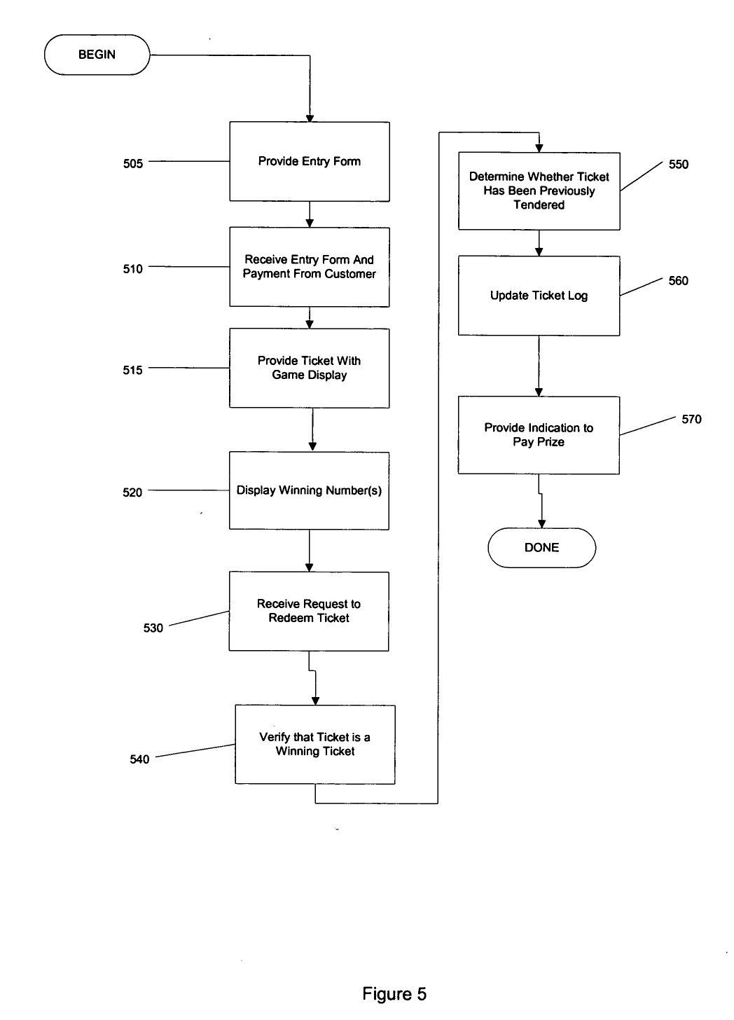

FIG. 5 illustrates an example procedure for facilitating the play of a game of chance, according to an example embodiment of the present invention. In 505, play options may be provided, e.g. by providing an entry form to a game customer, or by providing an on-line form on a selection machine or other display terminal. The play options may be provided upon request. It will be appreciated that a customer may use an entry form to select information for the play of the game.

In 510, play options may be received from a customer. The play options received may contain all the information that a customer wishes to be placed on a ticket. The play options may be received by a cashier or by an automated ticket point of sale system. Payment may also be received at this time.

In 515, a ticket with a game display is provided to a customer. For example, the ticket may be provided by a cashier or attendant, or via an automated ticket point of sale system. It will be appreciated that a customer may be anyone who receives a ticket. It will also be appreciated that the entry form may be used to generate the ticket.

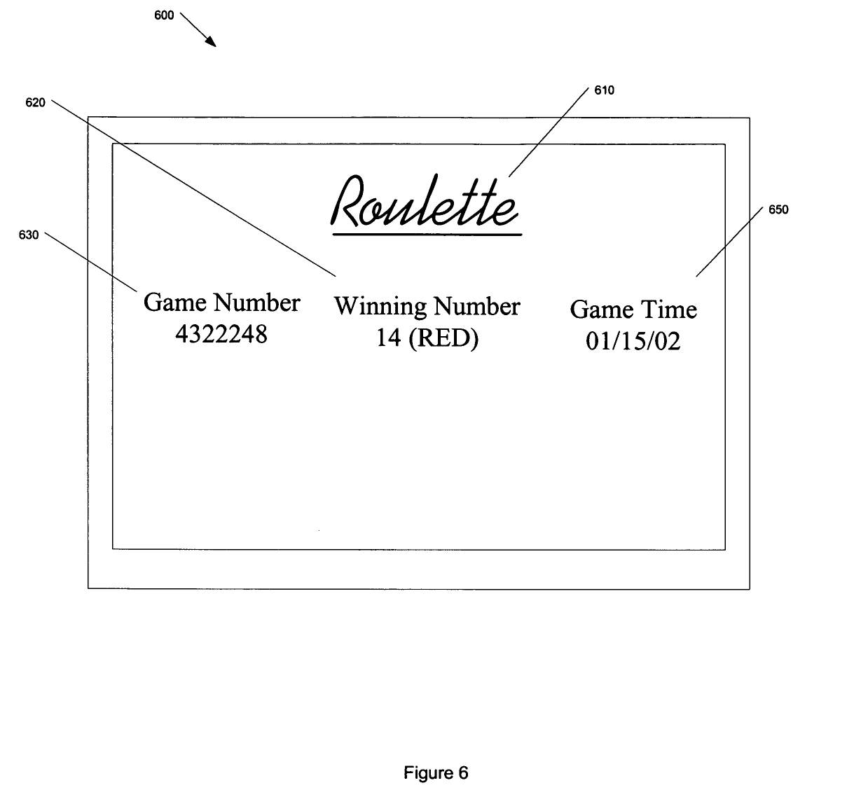

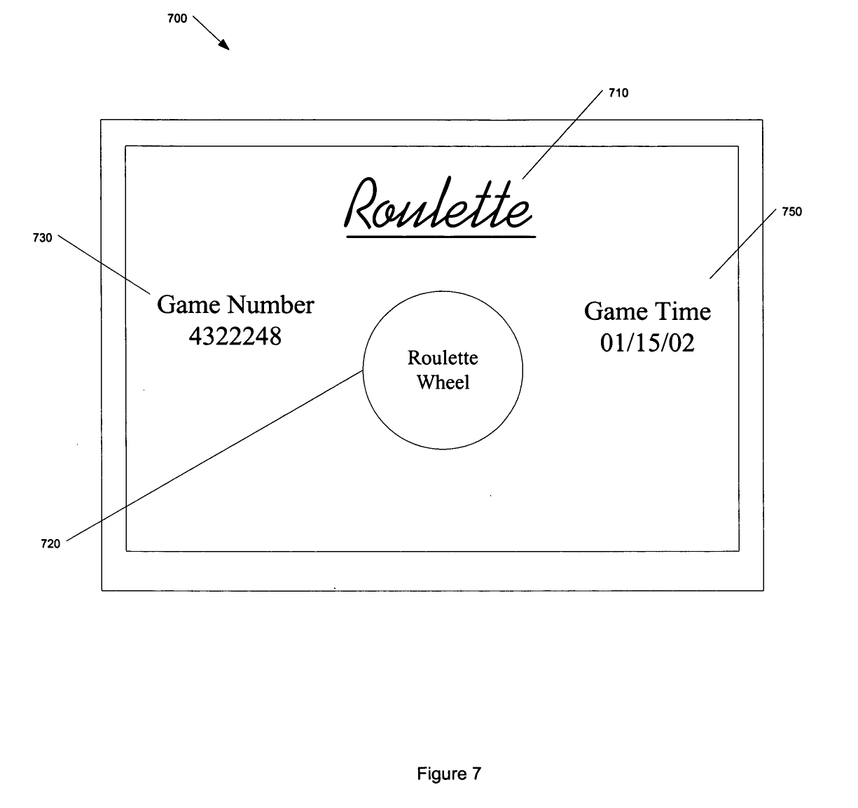

In 520, game play information may be displayed on a display terminal in the form of, for example a set of winning numbers and associated games. In this regard, more than one approach may be employed to display or highlight the winning numbers. Example display screens are shown in FIGS. 6 and 7. The display may be configured to display a corresponding drawn winning number for each game of Roulette, that is, each spin of the Roulette wheel. The drawn winning number may be depicted as corresponding with a particular game time.

In 530, a request to redeem a ticket may be received. In this regard, the ticket may be tendered, to a cashier or attendant, or via an automated point of sale system by inserting it into an automatic reader.

In 540, whether a ticket is a winning ticket may be verified. For example, an authentication code or other information uniquely identifying the ticket in a ticket, may be used to check a ticket log that includes information regarding previous sold tickets.

In 550, whether the tendered ticket has been previously tendered may be determined. For example, a field in a ticket log may be examined to verify that the tendered ticket has not been previously redeemed. In the event that the ticket log indicates that a ticket has been previously redeemed a message may be sent to the operator indicating that the ticket has been redeemed.

In 560, a ticket log may be updated to reflect the fact that the tendered ticket has been tendered for redemption. Updating the ticket log to reflect that a ticket has been tendered for redemption may prevent the same ticket from being redeemed a second time at a later date.

In 570, an indication may be provided that the cashier should redeem the tendered ticket, e.g., by displaying a prompt on a redemption system display. The amount to be paid may be displayed to the cashier, and/or directly to the person redeeming the ticket. It will be appreciated that this amount may be printed on a customer receipt. This indication may indicate both that the ticket should be redeemed and the amount for redemption. Alternatively, in an automated system, the ticket authentication procedure may initiate a ticket payment procedure automatically, once the ticket has been validated. The information regarding the ticket information may be read from a ticket log.

It will be appreciated that other actions may be included in the example procedure for authentication and payment. For example, electronic payment may require different procedures. Extra security measures may be provided for large prizes, or old tickets, or tickets that were sold at different establishments than the one redeeming the ticket.

Example Display Terminal Screen

FIG. 6 illustrates an example display terminal screen 600 according to an example embodiment of the present invention. The display terminal screen 600 may be configured to display information for the play of a game. It will be appreciated that the display terminal hardware may be the same type of display terminal currently used in lottery games, e.g. television.

The display terminal screen 600 may be configured to display the name of the game 610. In this instance, terminal screen 600 is configured to display “Roulette”. Additionally, other information may be displayed such as the rules of the game, advertisements, etc.

The display terminal screen 600 may be configured to display a game number 630 to indicate a particular game about to be played. For example, in FIG. 6, the game number is 4322248.

The display terminal screen 600 may be configured to display a winning number. For example, periodically, say every few minutes, a winning number may be obtained or generated. In this regard, the winning number, may be, for example, a number from 1 to 36 and a 00. The winning number may also represent a color, in this instance, for example, red, black or green. It will be appreciated that the range of winning numbers and/or associated characteristics of winning numbers may be configurable to accommodate a particular lottery need or to adjust the payout odds. For example, the range of winning numbers may be increased (e.g., 1 to 100 or adding “000”, “0000”) or the range of associated characteristics may be increased (e.g., adding more colors).

The display terminal screen 600 may be configured to display a game time field 650 to indicate the date or time of the present game. The game time field 650 may also indicate the time remaining until the next game is to be played.

It will be appreciated that the display terminal screen 600 may be configured to display additional information. For instance, information regarding the previous game or games, the number of winners of the previous game or advertising information may be displayed. It will be appreciated that one skilled in the art would know how to configure a display terminal to display winning number(s) for the playing of a Roulette game.

Second Example Display Terminal Screen

FIG. 7 illustrates a second example display terminal screen 700 according to an example embodiment of the present invention. The display terminal screen 700 may be configured to display information for the play of a game. It will be appreciated that the display terminal hardware may be the same type of display terminal currently used in lottery games, e.g. television.

The display terminal screen 700 may be configured to display the name of the game 710. In this instance, terminal screen 700 is configured to display “Roulette”. Additionally, other information may be displayed such as the rules of the game, advertisements, etc.

The display terminal screen 700 may be configured to display a game number 730 to indicate a particular game about to be played. For example, in FIG. 7, the game number is 4322248.

The display terminal screen 700 may be configured to display the generation of a winning number via a simulated spin of a Roulette wheel 720. In this regard, the drawing of the winning number may be represented, for example, by the spinning Roulette wheel 720 with a counter-spinning ball. The draw may occur, for example, periodically, say every few minutes, in which the winning number is generated. In this regard, the winning number, may be, for example, a number from 1 to 36 and a 00. The winning number may also represent a color, in this instance, for example, red, black or green. It will be appreciated that the displayed Roulette wheel 720 is configurable to adjust the range of winning numbers and/or its associated characteristics. It will also be appreciated that the multiple winning numbers may be generated per spin, using, for example, multiple Roulette balls that spin simultaneously.

The display terminal screen 700 may be configured to display a game time field 750 to indicate the date or time of the present game. The game time field 750 may also indicate the time remaining until the next game is to be played.

It will be appreciated that the display terminal screen 700 may be configured to display additional information. For instance, information regarding the previous game or games, the number of winners of the previous game or advertising information may be displayed. It will be appreciated that one skilled in the art would know how to configure a display terminal to display winning number(s) for the playing of a Roulette game.

Third Example Display Terminal Screen

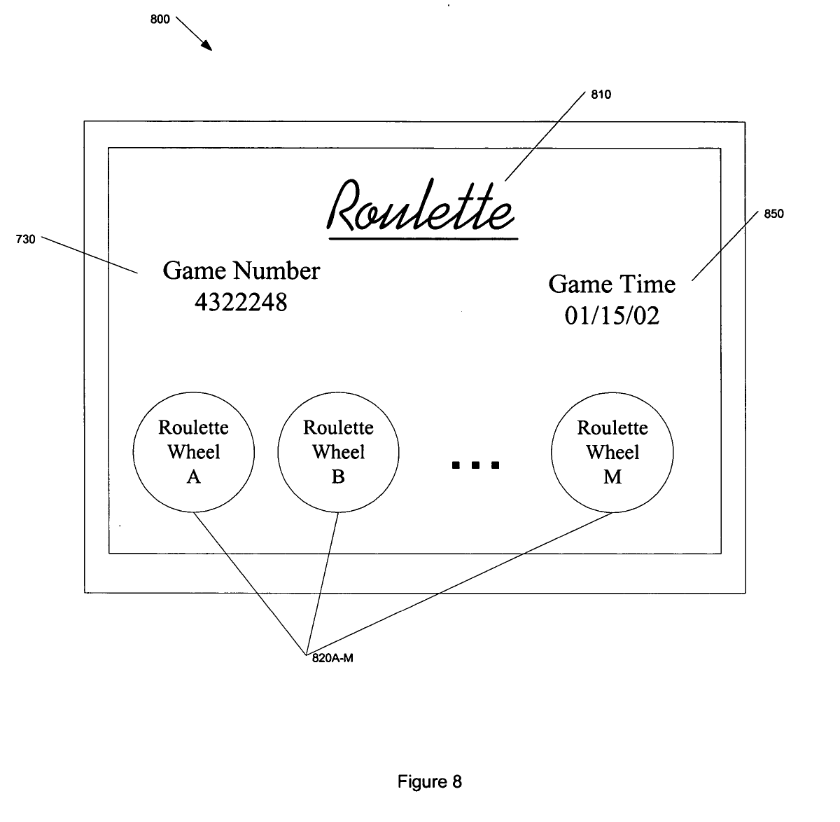

FIG. 8 illustrates a third example display terminal screen 800 according to an example embodiment of the present invention. The display terminal screen 800 may be configured to display information for the play of a game. It will be appreciated that the display terminal hardware may be the same type of display terminal currently used in lottery games, e.g. television.

The display terminal screen 800 may be configured to display the name of the game 810. In this instance, terminal screen 800 is configured to display “Roulette”. Additionally, other information may be displayed such as the rules of the game, advertisements, etc.

The display terminal screen 800 may be configured to display a game number 830 to indicate a particular game about to be played. For example, in FIG. 8, the game number is 4322248.

The display terminal screen 800 may be configured to display the generation of multiple winning numbers via a simulated spinning of multiple Roulette wheels 820A-M. In this regard, the drawing of the winning number may be represented, for example, by the spinning Roulette wheels 820A-M each with a counter-spinning ball. The draw may occur, for example, periodically, say every few minutes, in which the winning numbers are generated. In this regard, each winning number generated from the Roulette wheels 820A-M may correspond to a different bet on the same lottery ticket. For example, using the ticket of FIG. 1, the bets A-M may correspond Roulette wheels 820A-M.

The winning numbers, may be selected, for example, multiple numbers each selected from 1 to 36 and a 00. The winning numbers may also represent colors, in this instance, for example, red, black or green. It will be appreciated that the displayed Roulette wheel is configurable to adjust the range of winning numbers and/or its associated characteristics.

The display terminal screen 800 may be configured to display a game time field 850 to indicate the date or time of the present game. The game time field 850 may also indicate the time remaining until the next game is to be played.

It will be appreciated that the display terminal screen 800 may be configured to display additional information. For instance, information regarding the previous game or games, the number of winners of the previous game or advertising information may be displayed. It will be appreciated that one skilled in the art would know how to configure a display terminal to display winning number(s) for the playing of a Roulette game.

Example Game Chart of Payouts

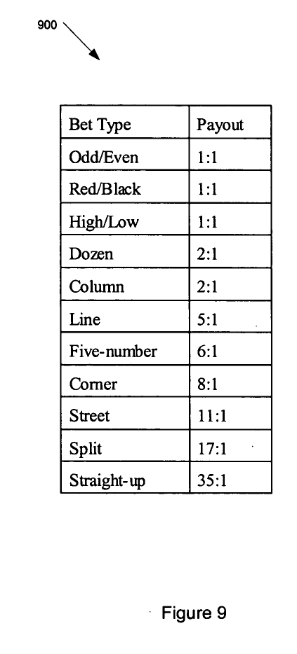

FIG. 9 illustrates an example chart 900 for determining whether a bet is a winning bet and if so the amount that may be won by the bet. This example chart may be printed on a ticket or made available to customers who purchase tickets. To determine whether a bet is a winning bet and if so the amount that may be won a ticket holder must know the bet type.

The example chart 900 represents exemplary payout odds for certain bet types. Similar charts may be provided for each bet amount. It will be appreciated that, alternatively, the payouts may be pari-mutuel based on odd and/or total bets in a particular venue and/or all bets in a particular region.

Example Ticket Log

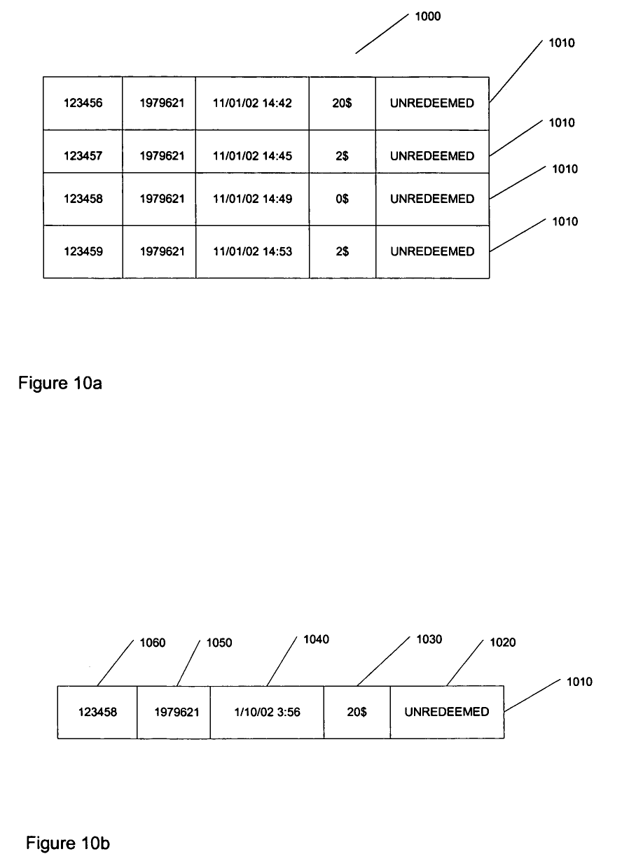

FIG. 10a illustrates an example ticket log 1000, according to an example embodiment of the present invention. The example ticket log 1000 may be used to keep track of tickets that have been sold, as well as whether sold tickets have been redeemed. The example ticket log 1000 may include a plurality of entries 1010, each entry corresponding to a ticket that has been sold. It will be appreciated that the ticket log, although illustrated as a table, may be stored in a variety of conventional data structures, e.g., as a linked list, or a custom-designed object. It will also be appreciated that the ticket log information may be incorporated in other data structures, rather than as a separate log, e.g., a relational database.

FIG. 10b illustrates an example entry 1010 from the example ticket log, according to an example embodiment of the present invention. The example entry 1010 may include a plurality of fields that provide information about a particular ticket that has been sold. The example entry 1010 may include a ticket number 1060 that uniquely identifies a ticket that has been sold. For example, the ticket number 1060 may be an authentication code.

The example entry 1010 may include a game field 1050 to indicate a particular game or games that the ticket is associated with.

The example entry 1010 may include a time field 1040 to indicate the time the corresponding ticket was sold.

The example entry 1010 may include a prize field 1030, to indicate the amount that will be paid upon the ticket redemption. This amount may be calculated based on the ticket information and the display information. In the event that a ticket is for multiple chances in a single game or multiple games then the prize field 1030 may represent the total amount won by a ticket (the total amount won by each chance in each game).

The example entry 1010 may include a redemption field 1020 to indicate whether the ticket has been redeemed, and if it has when the redemption occurred. It will be appreciated that the ticket log entry may include other fields not shown, e.g., an indication where or by whom the ticket was sold or redeemed, the value of the authentication code for the ticket, price information for the ticket, an indication of the symbols to be displayed for that game.

Example Lottery Terminal System

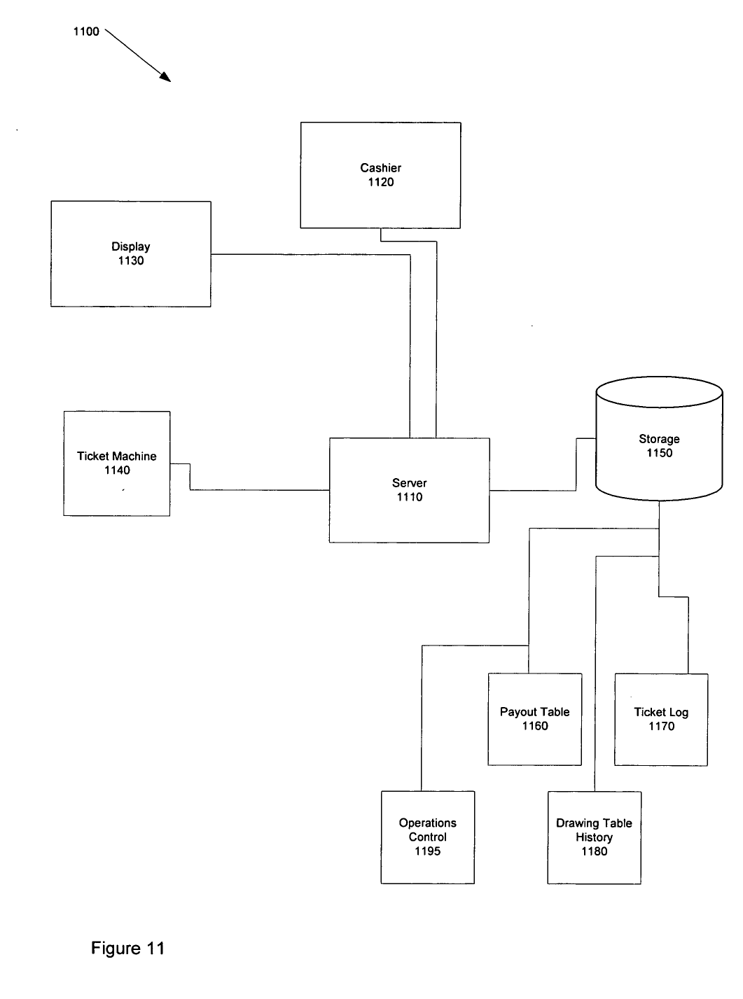

FIG. 11 illustrates an example lottery terminal system 1100 in logical view according to an example embodiment of the present invention. The example lottery terminal system may include one or more ticket machines 1140, one or more cashier machines 1120, and one or more or display devices or monitors 1130.

The example lottery terminal system 1100 may include a server 1110. The server 1110 may include a conventional microprocessor or custom designed control circuitry. The server 1110 may be in communication with the ticket machine 1140, cashier machine 1120, and display device 1130. The server 1110 may be used to control the operation of the other components of the lottery terminal system, e.g., by executing a control program that facilitates the play of a game of chance. The server 1110 may be configured to control the lottery terminal system 1100 in carrying out procedures for facilitating the play of a lottery game, generating drawn numbers, generating drawn symbols, and authenticating and paying winning lottery tickets, as were described above.

The example lottery terminal system 1100 may include a storage subsystem 1150. The storage subsystem 1150 may include RAM, ROM, disk, optical disk, flash memory, or other conventional storage media. The storage subsystem 1150 may be a separate component from the server 1110, or may be included as part of the server 1110.

Stored in the storage subsystem 1150 may be programs and data used to control or facilitate the play of lottery games. A game control program 1195 may be used to control the sale and redemption of gaming chances in the procedures for playing and facilitating the play of a lottery game that were described previously. The storage subsystem 1150 may also include a payout odds table 1160 that may be used to calculate the payout for winning bets. The storage subsystem 1150 may also include a ticket log 1170 that may be used to record the sale of tickets and facilitate procedures for redeeming tickets. The storage subsystem 1150 may further include a drawing table history 1180, that may be used to record drawing information for all drawings that have occurred, e.g., record drawn symbols and drawn numbers for each previous game.

It will be appreciated that the programs, payout odds table, and ticket log need not be located in a particular storage subsystem, e.g., they could reside directly on the server. It will also be appreciated that other elements may be included in the example lottery terminal system, e.g. operations control program, security, auditing capabilities, etc.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

What is claimed is:

1. A method of playing a game of chance, comprising:
selecting a bet using an entry form having markable areas associated with a table layout for a casino game;
receiving an indication of a winning number selected from a set of numbers displayed on the table layout; and
receiving a prize if the selected bet is associated with the winning number.

2. The method of playing a game of chance of claim 1, wherein
the selected bet is associated with the winning number if the selected bet matches the winning number.

3. The method of playing a game of chance of claim 2, wherein
the selected bet is associated with the winning number if the selected bet matches an associated characteristic of the winning number.

4. The method of playing a game of chance of claim 3, wherein
the associated characteristic includes at least one of a color and a relationship to other numbers.

5. The method of playing a game of chance of claim 1, further comprising:
viewing a video image of a live casino game.

6. The method of playing a game of chance of claim 1, further comprising:
viewing a video image of a simulated casino game.

7. The method of playing a game of chance of claim 1, further comprising:
wherein the casino game is one of Roulette and a modified version of Roulette.

8. The method of playing a game of chance of claim 1, further comprising:
receiving a ticket indicating the selected bet.

9. The method of playing a game of chance of claim 1, further comprising:
selecting a bet type, wherein the amount of the prize is a function of the bet type.

10. A method of playing a game of chance, comprising:
selecting a bet and a wager amount using an entry form having markable areas associated with a table layout for a Roulette game;
receiving a ticket indicating the selected bet and wager amount;
viewing a video image of the Roulette game indicating a winning number selected from a set of numbers displayed on the table layout;
tendering the ticket for a prize based on the wager amount; and
receiving the prize if the selected bet is associated with the winning number.

11. A method for facilitating the play of a game of chance, comprising:
receiving an indication of a bet placed on a table layout for a casino game; and
selecting a winning number from a set of numbers displayed on the table layout.

12. The method for facilitating the play of a game of chance of claim 11, further comprising:
receiving a ticket tendered for a prize.

13. The method for facilitating the play of a game of chance of claim 12, further comprising:
comparing the bet with the winning number to determine whether the ticket is a winning ticket; and
awarding the prize if the ticket is a winning ticket.

14. The method for facilitating the play of a game of chance of claim 11, wherein
the casino game is one of Roulette and a modified version of Roulette.

15. The method for facilitating the play of a game of chance of claim 11, wherein
the size of the prize is a function of a bet type.

16. The method for facilitating the play of a game of chance of claim 11, further comprising:
displaying the winning number.

17. A method for facilitating the play of a game of chance, comprising:
providing an entry form having a representation of a table layout for a Roulette game and a markable area to place an indication of a bet corresponding to the table layout and a wager amount, the indication simulating the placing of casino chips on the table layout;
receiving the entry form with the indication of the bet and the wager amount;
providing a ticket with an image of the table layout and an indication of the bet placed on the table layout and the wager amount;
selecting a winning number from a set of numbers displayed on the table layout;
displaying the winning number;
receiving a request to redeem the ticket;
comparing the bet placed on the table layout with the winning number to determine whether the ticket is a winning ticket; and
providing an indication to award a prize if the bet is associated with the winning number, wherein the size of the prize is based on the wager amount.

18. A ticket comprising:
an image of a table layout for a casino game; and
an indication of a bet placed on the table layout.

19. The ticket of claim 18, wherein
the casino game is one of Roulette and a modified version of Roulette.

20. The ticket of claim 18, further comprising:
an authentication code to validate the ticket.

21. The ticket of claim 18, wherein
the ticket is redeemable for a prize if the bet matches at least one of a winning number and an associated characteristic of the winning number.

22. The ticket of claim 21, further comprising:
an indication of a bet type.

23. The ticket of claim 22, further comprising:
the size of the prize is a function of the bet type.

24. A lottery ticket, comprising:
an image of a table layout for a Roulette game;
an indication of a bet placed on the table layout and a wagered amount;
a game number to identify a particular instance of the Roulette game;
a drawing time for the game number; and
an authentication code to validate the ticket,
wherein the ticket is redeemable for a prize based on the wagered amount if the bet matches at least one of a winning number and an associated characteristic of the winning number, the winning number being selected from a set of numbers displayed on the table layout.

25. A lottery entry form, comprising:
a representation indicative of a table layout for a casino game; and
an area to place an indication of a bet corresponding to the table layout.

26. The lottery entry form of claim 25, wherein
the entry form is configured on a printable medium.

27. The lottery entry form of claim 25, wherein
the entry form is configured as an on-line form.

28. The lottery entry form of claim 25, wherein
the casino game is one of Roulette and a modified version of Roulette.

29. The lottery entry form of claim 25, wherein
the indication is readable by a lottery terminal.

30. The lottery entry form of claim 25, wherein
the indication simulates the placing of casino chips on the table layout.

31. The lottery entry for of claim 25, further comprising:
an area to select a quick pic.

32. A lottery entry form, comprising:
a representation indicative of a table layout for a Roulette game; and
a markable area to place an indication of a bet corresponding to the table layout and a wager amount, the indication being machine readable, the bet including at least one of a straight-up bet, a split bet, a street bet, a corner bet, a five-number bet, a line bet, an odd/even bet, a red/black bet, a column bet, a dozen bet, a five-number bet, and a line bet.

33. An article of manufacture comprising a computer-readable medium having stored thereon instructions adapted to be executed by a processor, the instructions which, when executed, define a series of steps to be used to control a method of facilitating a game of chance, the method comprising:
generating a ticket including an indication of a bet placed on a table layout for a casino game;
generating a winning number from a set of numbers displayed on the table layout; and
redeeming the ticket when tendered for a prize the size of which is a function of the a bet type.

34. A system for facilitating the play of a game of chance, comprising:
a ticket machine for generating tickets having an indication of a bet placed on a table layout for a casino game;
a display terminal configured to display a winning number selected from a set of numbers displayed on the table layout;
a storage device for storing information regarding the tickets generated by the ticket machine; and
an operations controller for generating the winning number.
